(19) United States
(12) Patent Application Publication
(10) Pub. No.: US 2024/0337983 A1
(43) Pub. Date: Oct. 10, 2024

(54) CONTROL OF PROBE BEAM DURATION IN SINGLE WAVELENGTH MONITORING OF HOLOGRAM DIFFRACTION EFFICIENCY

(71) Applicant: Arizona Board of Regents on Behalf of the University of Arizona, Tucson, AZ (US)

(72) Inventors: Raymond Kostuk, Tucson, AZ (US); Benjamin Chrysler, Tucson, AZ (US); Jianbo Zhao, Tucson, AZ (US)

(21) Appl. No.: 18/682,607

(22) PCT Filed: Aug. 11, 2022
(86) PCT No.: PCT/US2022/074821

§ 371 Date: Feb. 9, 2024

Related U.S. Application Data
(60) Provisional application No. 63/231,996, filed on Aug. 11, 2021.

(51) Int. Cl. G03H 1/04; G03H 1/02

(52) U.S. Cl. CPC G03H 1/0486; G03H 1/0248; G03H 2001/0439; G03H 2001/0491; G03H 2240/53

(57) ABSTRACT

Methods, devices and systems are described that enable monitoring the diffraction efficiency of holographic material in real-time while they are being formed. One example method includes directing a reference beam and an object beam toward a holographic material for formation of a diffraction grating and blocking one of the beams for at least a portion of time during which the diffraction grating is being formed. The method further includes, upon blockage of one of the beams, based on power level measurements, determining whether or not a first diffraction efficiency is reached. If the first diffraction efficiency is reached, one of the reference or the object beams is disabled or blocked while the other beam illuminates the holographic material with a particular duty cycle. Further measurements of the diffraction efficiency are made until the final diffraction efficiency is reached.

### CROSS REFERENCE TO RELATED APPLICATION(S)

This application claims priority to the provisional application with Ser. No. 63/231,996 titled “CONTROL OF PROBE BEAM DURATION IN SINGLE WAVELENGTH MONITORING OF HOLOGRAM DIFFRACTION EFFICIENCY,” filed Aug. 11, 2021. The entire contents of the above noted provisional application are incorporated by reference as part of the disclosure of this document.

### STATEMENT REGARDING FEDERALLY SPONSORED RESEARCH

This invention was made with government support under Grant Nos. EEC-1041895 and 1143953, awarded by NSF. The government has certain rights in the invention.

### TECHNICAL FIELD

The disclosed technology relates to holographic elements and in particular to methods, devices and systems for improved fabrication and measurement of holographic elements.

### BACKGROUND

Volume holographic elements (VHOEs) have many applications ranging from display systems, medical devices, and solar energy systems. One important characteristic of a VHOE is the diffraction efficiency, which measures how much of the incident power is diffracted into a particular diffraction order. Most VHOEs must attain a certain diffraction efficiency depending on the application. In many applications, the diffraction efficiency should be maximized, while in others, such as exit pupil expanders in waveguide display systems, the diffraction efficiency is intentionally selected to be a lower value. Regardless of the application, the diffraction efficiency of the fabricated element should match the design constraint as closely as a possible, and therefore there is a need to accurately measure the diffraction efficiency as the holographic element is being fabricated in order to match the desired diffraction efficiency.

### SUMMARY

The disclosed embodiments enable monitoring the diffraction efficiency of VHOEs in real-time with higher accuracy and greater simplicity than prior techniques.

One example method for production and real-time measurement of a hologram includes directing a reference beam and an object beam toward a holographic material for formation of a diffraction grating in the holographic material, and blocking the reference beam or the object beam to prevent the corresponding beam to reach the holographic material for at least a portion of time during which the diffraction grating is being formed. The method also includes, upon blockage of one of the reference or object beams, measuring a power level of a diffracted beam associated with the reference or the object beam that is not being blocked, and determining whether or not a first diffraction efficiency that is different from a final diffraction efficiency is reached based on the measured power level. Upon a determination that the first diffraction efficiency is reached, the method also includes blocking or otherwise disabling one of the reference or the object beams while allowing the other of the reference or the object beams to illuminate the holographic material with a particular duty cycle to enable further measurements of diffraction efficiency, and conducting the further measurements of the diffraction efficiency using the reference or the object beam that is not blocked or otherwise disabled until the final diffraction efficiency is reached.

### BRIEF DESCRIPTION OF THE DRAWINGS

FIG. 1 illustrates a real-time measurement system for monitoring and measuring the diffraction efficiency of a HOE which is being formed in accordance with an example embodiment.

FIG. 2A illustrates a configuration of a real-time system for monitoring diffraction efficiency of an HOE corresponding to a non-TIR transmission-type recording setup in accordance with an example embodiment.

FIG. 2B illustrates a configuration of a real-time system for monitoring diffraction efficiency of an HOE corresponding to a TIR transmission-type recording setup in accordance with an example embodiment.

FIG. 2C illustrates a benchtop setup to conduct real-time monitoring and measurement of diffraction efficiency of an HOE in a non-TIR transmission-type recoding method in accordance with an example embodiment.

FIG. 3 illustrates an example diagram of the modulated recording power of the construction beams as a function of time in accordance with an example embodiment.

FIG. 4 illustrates a plot of the diffracted beam power monitored during and after the formation of a hologram as a function of time in accordance with an example embodiment.

FIG. 5 illustrates a plot of the modulated recording power as a function of time that enables monitoring and measurement of the diffraction efficiency of an HOE in accordance an example embodiment.

FIG. 6 illustrates example plots of the diffracted beam power that was monitored during and after the formation of three HOEs as a function of time in accordance with example embodiments.

FIG. 7 illustrates example plots of the monitored diffracted power versus time, the final power versus stopped power and associated labeling conventions.

FIG. 8 illustrates a set of operations that can be carried out for real-time measurement of diffraction efficiency of a hologram in accordance with an example embodiment.

### DETAILED DESCRIPTION

The diffraction efficiency is dependent at least in-part on the exposure energy of the light exposing the holographic material during fabrication. The most basic technique for controlling the diffraction efficiency of the fabricated element is to characterize the holographic material's diffraction efficiency as a function of exposure energy by fabricating a set of holograms with different exposure energies and measuring the diffraction efficiency of each. The exposure energy from the sample set that most closely matches the design constraint is then used to fabricate the desired VHOE. This technique, however, requires fabrication of additional material, and may not produce the desired diffraction efficiency due to differences in the materials of the fabricated pieces or laser power fluctuations. In another technique, light from a separate laser at a different wavelength than the construction wavelength, and at a separate incident angle, is used to measure the diffraction efficiency. The diffraction efficiency at the construction wavelength can then be estimated through mathematical approximations. However, this method requires additional equipment and complicated experimental setups, and the mathematical approximations reduce the accuracy of the method. In addition, the hologram's diffraction efficiency still changes, even after the recording has stopped, due to the diffusion process of the monomers.

The disclosed embodiments overcome these and other deficiencies of the prior techniques and enable monitoring the diffraction efficiency of VHOEs in real-time with higher accuracy and greater simplicity. These and other features and benefits are achieved in-part by using a shutter or a chopper to periodically block one the of the exposing beams during the fabrication, and measuring the power of the diffracted beam using a power meter. Once the measured diffraction efficiency of the VHOE reaches a first value, the construction beams are blocked. Post-exposure diffraction efficiency growth due to diffusion is then monitored with a single modulated beam to determine the point when the diffraction efficiency either saturates or reaches a maximum. Since the measurements are performed in real-time, the disclosed techniques can account for the local variations in the material or laser power that cause the necessary exposure time to fluctuate between samples. Therefore, the disclosed embodiments enable improved fabrication of VHOEs in general, and enable fabrication VHOEs that must meet precise tolerances in their required diffraction efficiency.

One example application of the disclosed techniques relates to fabrication of VHOEs for use in display systems, including but not limited to, use in wearable display systems, where precise diffraction efficiency needs to be attained to ensure the irradiance distribution of light diffracted from the waveguide is uniform. In one application related to exit pupil expanders (EPE), the diffraction efficiency of the VHOEs must by tightly controlled since light passes through the VHOE many times before being diffracted out. As an additional complication, these elements typically need to have a low diffraction efficiency. Low diffraction efficiency elements are more difficult to fabricate precisely since the material is highly sensitive in this regime.

Another example application of the disclosed embodiments relates to formation of multiplexed holograms. Repeatable and uniform results are notoriously difficult to achieve for multiplexed holograms since the sensitivity of the hologram changes between each hologram. Using the disclosed embodiments, multiplexed holograms formation can be improved by monitoring the diffraction efficiency of the element as it is being formed and precisely controlling the exposure energy of each multiplexed hologram so that each has the correct diffraction efficiency.

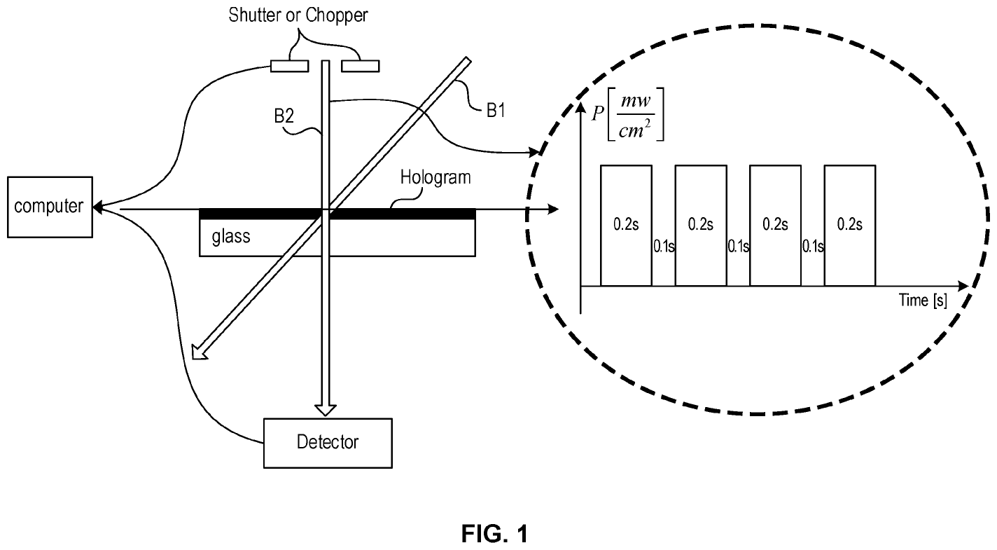

The disclosed operations may be further illustrated using the configuration of FIG. 1 which illustrates a real-time measurement system for monitoring and measuring the diffraction efficiency of a HOE which is being formed. In this configuration, beams B1 and B2 are the construction beams that are incident on the hologram with a glass substrate. A shutter or a chopper is placed in the path of one of the two incident beams and is configured to block the associated beam. In some embodiments, a computer, a controller or a similar device is used to control the operations of the shutter or the chopper. A detector (which can also be controlled by the computer or the controller) is placed in the diffracted path of the beam that does not have the shutter. While the shutter is open (or the chopper is not blocking the beam), fringes are present on the hologram and the grating is being formed. When the shutter is closed (or the chopper is blocking the beam), only a single beam is incident on the hologram and is diffracted onto the detector and measured. In this way, no additional setups or lasers are necessary for measuring the diffraction efficiency of the hologram, and the diffraction efficiency is measured directly from the construction beams.

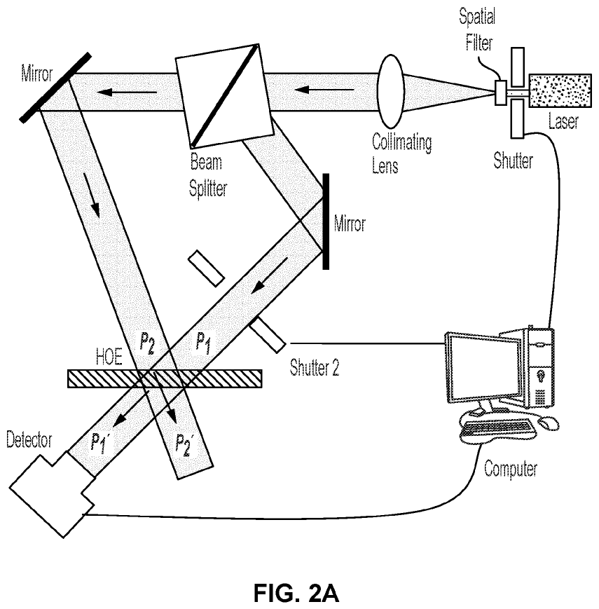

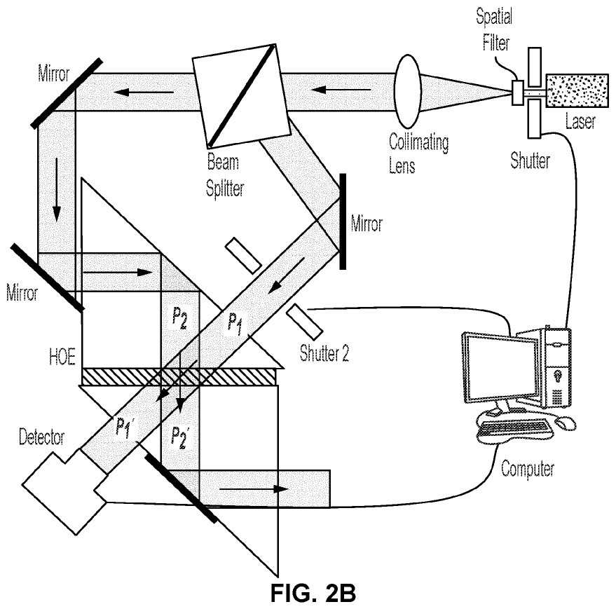

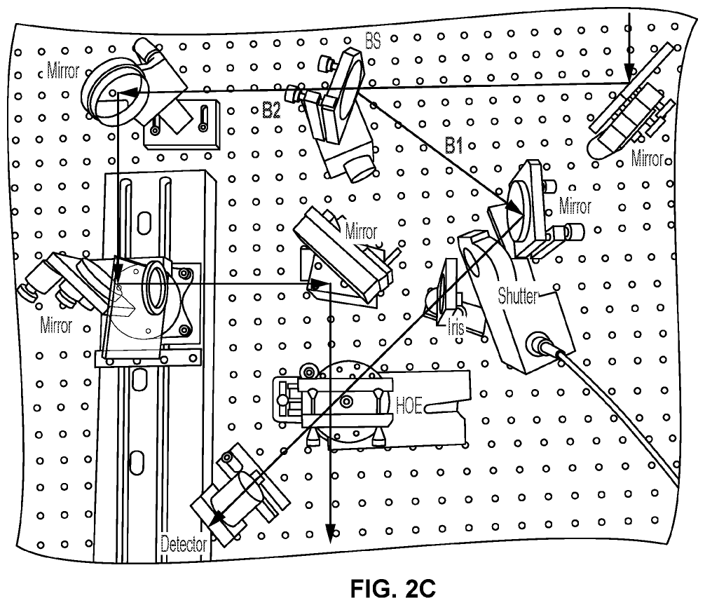

FIGS. 2A and 2B illustrate two example implementations of a real-time system for monitoring the diffraction efficiency of an HOE. FIG. 2A represents a non-TIR transmission-type HOE recording setup. In this implementation, a laser beam is provided to a collimating lens that produces a collimated beam directed to a beam splitter. The laser beam may be expanded and spatially filtered with a spatial filter to provide the desired spatial beam profile for a specific application. For example, the spatial filter may produce a point source. An electronically modulated shutter may also be inserted in this beam to modulate the laser beam at a specific frequency that can be locked on for monitoring. The monitoring operations will be discussed in further detail below. The beam is then divided by the beam splitter and the reflected and transmitted components are directed to mirrors and combined at the plane of the recording material (HOE). A second shutter may be placed in the path of one of the beams (P₁ in the example configuration of FIG. 2A), while the other beam (P₂) is allowed to reach the HOE uninterrupted. In this configuration, the beam P₁ can represent the object beam while the beam P₂ can represent the reference beam. When the object beam (P₁) is unblocked, the grating is being formed, and when the object beam (P₁) is blocked, the reference beam (P₂) is diffracted and reaches the detector. In FIG. 2A, P₁′ and P₂ represent the measured power of the two recording beams after passing through the hologram. A device (e.g., a PC, laptop, a controller, processor, etc.) can control the operations of the choppers, the laser, and the detector, and further receive and process measurement information from the detector. The configuration of FIG. 2A can be advantageous in some applications, such as during the formation of multiplexed holograms, where many holograms are being recorded consecutively. If the object beam is fixed at an angle, then the detector can be placed in the path of the object beam without requiring the detector to be moved during the recording.

FIG. 2B illustrates an example TIR transmission-type HOE recording setup. FIG. 2B has similar components as FIG. 2A but includes an additional mirror in the path of one of the beam (i.e., P₂ in FIG. 2B) to allow the beam to enter a top prism, be reflected via total internal reflection (TIR) before reaching the recording material (HOE). Similar to FIG. 2A, when the object beam is unblocked, the grating is being formed. When the object beam is blocked, the reference beam is diffracted and reaches the detector after traveling through a bottom prism. The bottom prism is used to couple the recording beam out from the holographic film while reducing the reflections on the bottom surface of the hologram. The beam P₂′ can exit the bottom prism after reflection from a further mirror on a facet of the bottom prism.

FIG. 2C illustrates an example benchtop setup that was used conduct real-time monitoring and measurement of the diffraction efficiency. For example, FIG. 2C can be used to implement a non-TIR transmission-type HOE recoding method. The components in FIG. 2C are similar to those described in connection with FIGS. 2A and 2B. In the setup of FIG. 2C, an optical shutter (corresponding to the second shutter in FIGS. 2A and 2B) with a duty cycle of 90% and a frequency of 1 Hz was used. The two construction beams at 532 nm had incident angles of 47° and 0)°. A Thorlabs Slim Photodiode Power Sensor S130C was used for making the measurements. The incident beam is split by the beam splitter, producing two beams, B1 and B2. A shutter and an iris are positioned in the path of B1, after reflection from a mirror, to selectively block or unblock B1 that reaches the HOE. B2 is reflected from three mirrors before reaching the HOE. The detector is positioned behind the HOE, which receives and measures the light incident thereon.

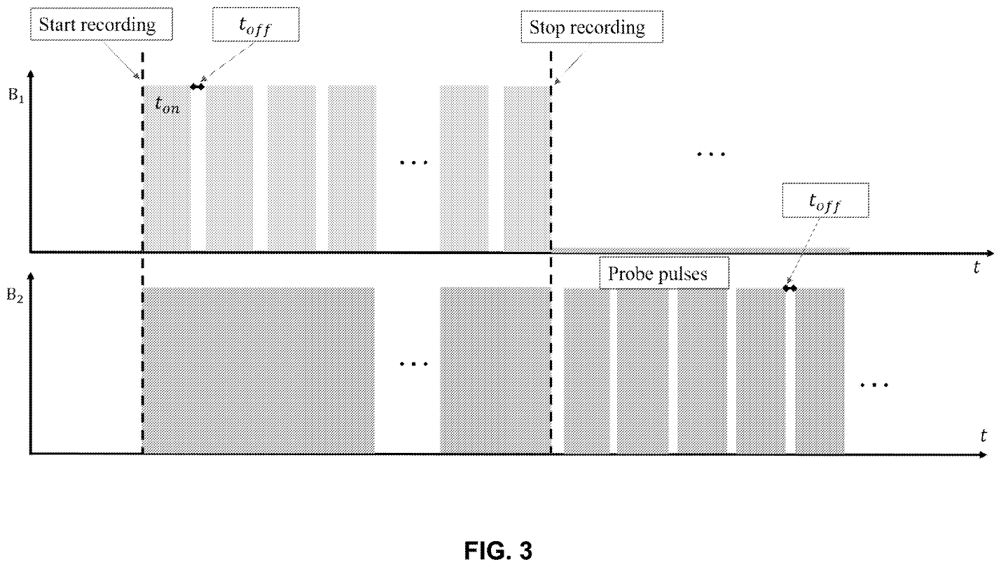

FIG. 3 illustrates an example of the modulated recording power as a function of time. When the recording starts, beams B1 and B2 are both turned on, and B1 is modulated with the designed duty cycle and frequency. In this case, the power attained by the detector is diffracted by the formed HOE with illumination from B1. Notice that when B1 is blocked, only B2 is illuminating the HOE, resulting in the consumption of free monomers. Thus, the ratio of the off-time to the single period should be rather small (e.g., less than 10%). When beam B1 is turned on, the grating is formed within the material: otherwise, the recording is stopped. Thus, the diffraction efficiency of the HOE during the fringe formation process can be monitored in real-time. After the recording is completed, beam B1 is turned off, but the formation of the diffraction grating may still continue. As such, beam B2 is periodically modulated to produce the diffracted signal that indicates the diffraction evolution. In this case, the probe pulse time is relatively longer than the light-off time, which can provide the diffraction efficiency degradation information while the formed grating is post-illuminated with one of the recording beams.

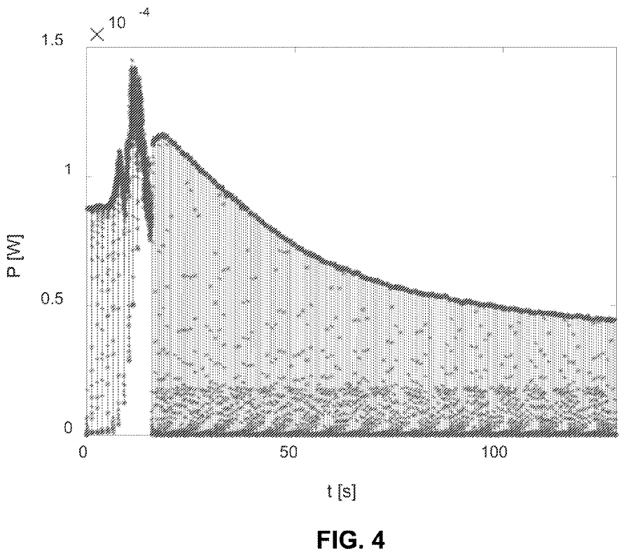

FIG. 4 illustrates an example plot of the diffracted beam power that was monitored during and after the formation of a hologram as a function of time using a modulation pattern similar to that shown in FIG. 3. The curve formed on the lower part of the modulated envelope is the diffracted beam power: as the diffraction grating is being formed, the lower part of the oscillatory power plot starts to trend upward. In this example, the beam power is not normalized, but the diffraction efficiency can be easily obtained from these plots through normalization (e.g., dividing by total power). The diffracted beam power increases steadily and reaches a maximum after ˜20 seconds when the recording is stopped at 10 seconds. The ultimate diffraction efficiency is degraded significantly (by ˜50%) due to post-formation illumination with one of the recording beams. Thus, the diffraction efficiency degradation caused by post-formation illumination can be studied using the disclosed measurement techniques to enable accurate recording of the HOEs to achieve the desired diffraction efficiencies.

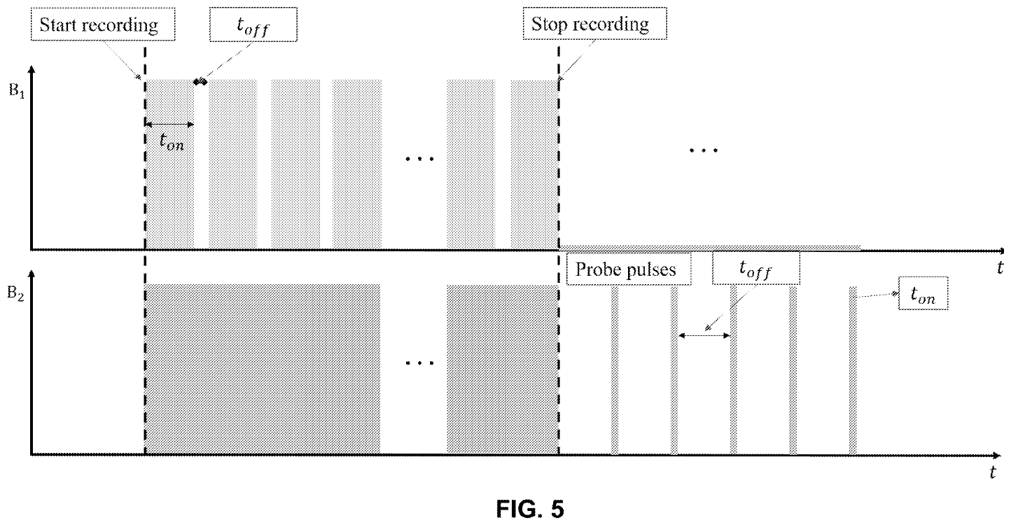

FIG. 5 illustrates an example of the modulated recording power as a function of time that enables monitoring and measurement of the diffraction efficiency of an HOE in accordance with some embodiments. When the recording starts, beams B1 and B2 are both turned on, and B1 is modulated with the designed duty cycle and frequency. In this case, the power attained by the detector is diffracted by the formed HOE with illumination from B1. Similar to FIG. 3, when beam B1 is turned on, the grating is formed within the material. After the recording is completed, beam B1 is turned off, and beam B2 is periodically modulated to produce the diffracted signal that indicates the diffraction efficiency evolution. In this case, the probe pulse on-time is relatively shorter than the light-off time, which can provide the diffraction efficiency evolution information without degrading the hologram's efficiency. In some embodiments the reference beam is used as the probe beam for post-recording illumination and monitoring while the object beam is blocked. In other embodiments, the object beam may appropriately shuttered and used for post-recording illumination and monitoring while the reference beam is blocked.

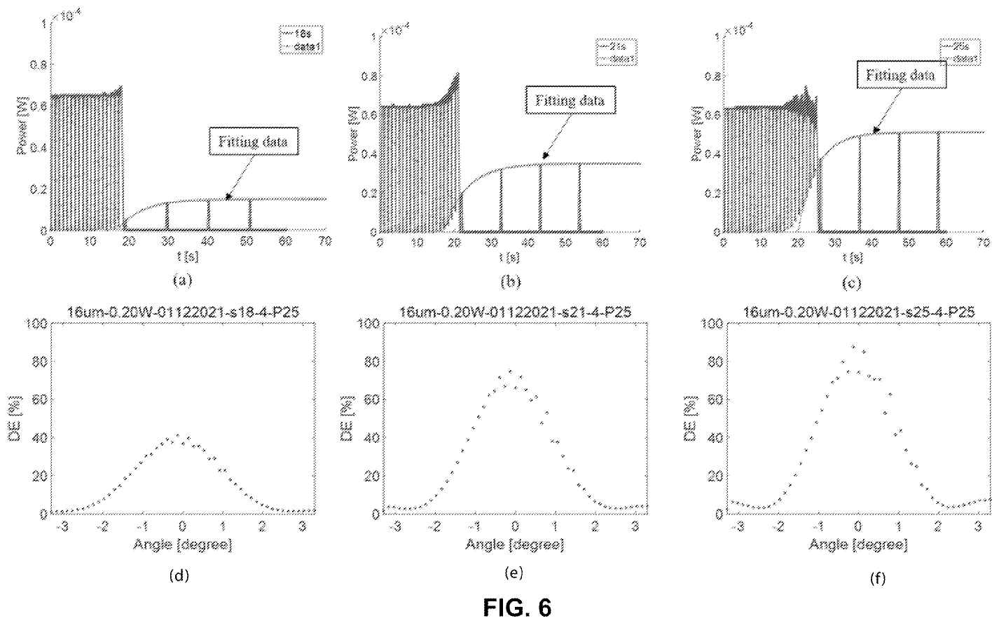

To more comprehensively study the diffraction efficiency evolution after the exposure, more HOEs were fabricated with the experimental setup of FIG. 2C and using modulated recording power patterns similar to those in FIG. 5. The irradiance of the exposure was reduced to 0.2 mW/cm² to provide a slower diffraction efficiency variation as a function of time. The detected signals as a function of time for three HOEs are shown in FIG. 6, panels (a), (b) and (c) with stop-recording time points at 18 seconds, 21 seconds, and 25 seconds, respectively. The curves labeled as “Fitting data” in all three graphs are the fitted data calculated with the monomer diffusion equation. In these experiments, after the stop recording point, the on-time of the monitor beam was less than 10% of a single period. In other implementations, the post-recording illumination beams can have on-times of less than 50%, for example, 15% or 20%.

It is evident from these plots that although the HOE recording is stopped, the measured data indicate the diffraction efficiency is still changing after the stoppage. This signal evolution indicates that the monomer diffusion process occurs after the end of the exposure, and it gets to a stable status approximately 30 seconds after the stop recording time instance. The diffraction efficiency (DE) evolution is attributed to the dark reaction time needed for the recorded HOE to reach a stable or saturated status without extra incurring diffusion. In addition, the associated diffraction efficiencies as a function of the measured reconstruction angle associated with the recording processes in panels (a)-(c) are given in FIG. 6, panels (d)-(f), respectively. These plots indicate that an increase in the stopped recoding time (from (a) to (c)) results in an increase in the diffraction efficiency in (d) to (f).

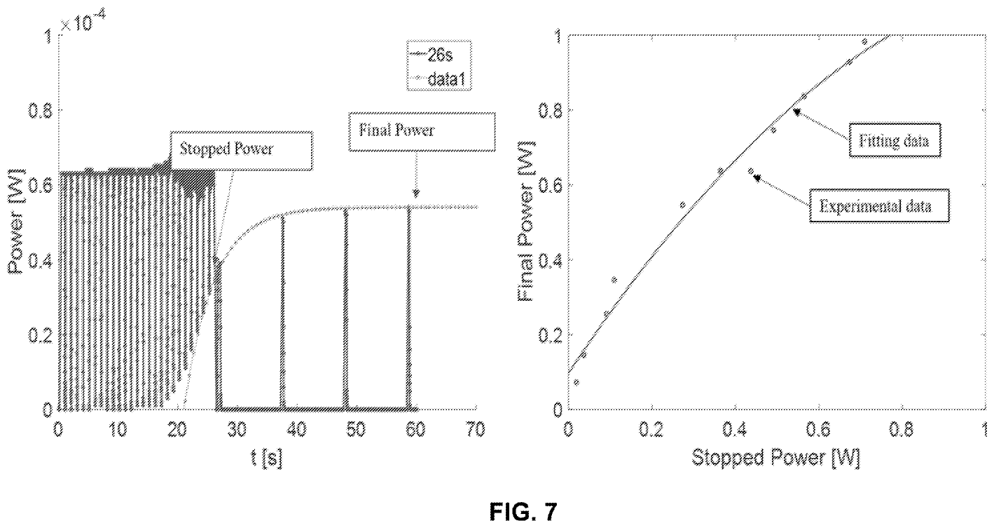

The left-hand side of FIG. 7 illustrates our convention for labeling an example measurement plot with a stopped power-point and a final saturated power-point. Based on this convention, the correlation between the normalized stopped power-points and the saturated (final) power-point is plotted on the right-hand side of FIG. 7. In the right-hand side plot, each saturated power-point corresponds to a stopped power-point, and the relationship between them is not linear. Therefore, instead of monitoring the exposure time used in the recording, the normalized stopped power can be implemented in the disclosed embodiments to accurately predict the saturated power without concerning how much irradiance or how long the exposure time is needed to attain the designed diffraction efficiency value.

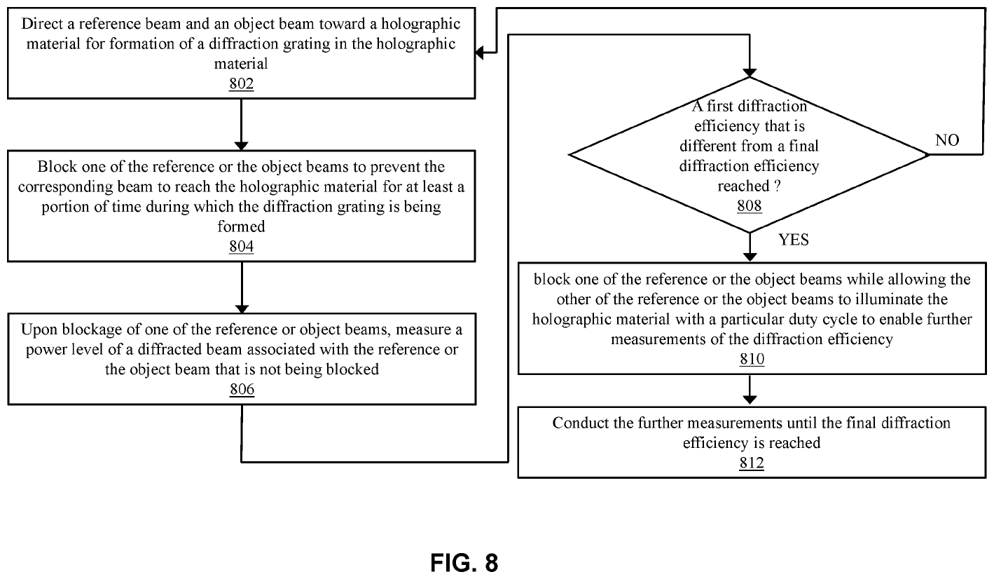

FIG. 8 illustrates a set of operations that can be carried out for real-time measurement of diffraction efficiency of a hologram in accordance with an example embodiment. These operations can be performed to produce a hologram having a desired diffraction efficiency. At 802, a reference beam and an object beam are directed toward a holographic material for formation of a diffraction grating in the holographic material. At 804, one of the reference or the object beams is blocked to prevent the corresponding beam to reach the holographic material for at least a portion of time during which the diffraction grating is being formed. At 806, upon blockage of one of the reference or object beams, a power level of a diffracted beam associated with the reference or the object beam that is not being blocked is measured. At 808, a determination is made as to whether or not a first diffraction efficiency that is different than a final diffraction efficiency is reached based on the measured power level. If the determination indicates that the first diffraction grating efficiency is not reached (“NO” at 808), then both beams are allowed to illuminate the holographic material to continue the formation of the diffraction grating, with operations returning to 802. If the determination indicates that the first diffraction grating efficiency is reached (“YES” at 808), then, at 810, one of the reference or the object beams is blocked while allowing the other of the reference or the object beams to illuminate the holographic material with a particular duty cycle to enable further measurements of the diffraction efficiency. At 812, the further measurements are conducted until the final diffraction efficiency is reached. For example, the further measurements can continue until the diffraction efficiency either saturates or reaches a maximum value. The determination as to whether the first diffraction efficiency is reached can be carried out by measuring the power level of the diffracted beam and comparing it to a power value corresponding to a stoppage point that would produce a final measured power value after the hologram has evolved to a final state.

It should be noted that, in order to simplify the explanations, the flow chart in FIG. 8 illustrates the operations from decision box 808 returning to the initial box that recites operations 802. Based on the above explanation, it is understood, however, that upon returning to the initial box 802 after a determination that the first diffraction efficiency is not reached, it suffices to unblock one of the beams (that was being blocked during the measurement) in order to expose the holographic material to both beams. As also described earlier, the blocking and unblocking of the beam can be carried out, for example, in a periodic or an intermittent fashion using a chopper or a shutter.

The disclosed measurement techniques can be tuned, optimized or otherwise adjusted based on several parameters. Examples of such parameters include the duty cycle and the frequency of the shutter. The inset in FIG. 1 illustrates an example plot of the measured power as a function of time corresponding to shutter-on and shutter-off times of 0.2 and 0.1 seconds, respectively (a frequency of 3.3 Hz and a duty cycle of 66%). The duty cycle and frequency parameters are important because the probe beam may affect the internal diffusion of monomers inside the photopolymer and affect the formation and post-formation evolution of the hologram. In some embodiments, a greater duty cycle may be implemented during the formation to reduce the time during which the hologram is exposed to only one beam, thus decreasing the associated adverse effects on the formation of the hologram. In some implementations, a duty cycle of greater than 90% may be used during formation. In some embodiments, a greater shutter frequency may be implemented to obtain a higher sampling rate, which allows the change in diffraction efficiency to be monitored with improved temporal resolution. In some implementations, the frequency can be adjusted from a low value to a high value in accordance with the resolution of the detector. An example range of frequencies includes 10 Hz to 1000 Hz. The disclosed techniques can be adapted for many different exposing geometries for making VHOEs, including total internal reflection (TIR) and non-TIR setups.

One aspect of the disclosed embodiments relates to a method for production and real-time measurement of a hologram that includes directing a reference beam and an object beam toward a holographic material for formation of a diffraction grating in the holographic material, and blocking the reference beam or the object beam to prevent the corresponding beam to reach the holographic material for at least a portion of time during which the diffraction grating is being formed. The method further includes upon blockage of one of the reference or object beams, measuring a power level of a diffracted beam associated with the reference or the object beam that is not being blocked, and determining whether or not a first diffraction efficiency that is different from a final diffraction efficiency is reached based on the measured power level. Upon a determination that the first diffraction efficiency is reached, the method additionally includes blocking or otherwise disabling one of the reference or the object beams while allowing the other of the reference or the object beams to illuminate the holographic material with a particular duty cycle to enable further measurements of diffraction efficiency. Further, the method includes conducting the further measurements of the diffraction efficiency using the reference or the object beam that is not blocked or otherwise disabled until the final diffraction efficiency is reached.

In one example embodiment, the final diffraction efficiency is reached when the measured diffraction efficiency either saturates or reaches a maximum value. In another example embodiment, determining whether or not the first diffraction efficiency is reached includes comparing the measured power level to a stoppage point power value. In yet another example embodiment, the stoppage point power value is related to a power value associated with the final diffraction efficiency by a non-linear relationship. In still another example embodiment, the particular duty cycle is less than 50 percent, having an on-time that is less than an off-time in each cycle. In another example embodiment, the particular duty cycle is 10% or less.

According to one example embodiment, upon the determination that the first diffraction efficiency is reached, the above noted method includes blocking or otherwise disabling the object beam while allowing the reference beam to illuminate the holographic material with the particular duty cycle. In another example embodiment, blocking one of the reference or the object beams includes operating a chopper that periodically blocks a path of one of the reference beam or the object beam. In still another example embodiment, blocking one of the reference or the object beams includes operating a shutter that intermittently or periodically blocks a path of one of the reference beam or the object beam.

In another example embodiment, blocking one of the reference or the object beams while the diffraction grating is being formed consists of blocking the object beam, and measuring the power level of the diffracted beam consists of measuring the power level of the diffracted reference beam. In yet another example embodiment, blocking one of the reference or the object beams while the diffraction grating is being formed consists of blocking the reference beam, and measuring the power level of the diffracted beam consists of measuring the power level of the diffracted object beam.

According to one example embodiment, the above noted method for production and real-time measurement of a hologram includes, upon a determination that the first diffraction efficiency is not reached, (a) allowing both the reference beam and the object beam to illuminate the holographic material to continue formation of the diffraction grating, (b) subsequent to illumination of the holographic material by both the reference and object beams for a duration of time, blocking one of the reference or the object beams, (c) making one or more additional power level measurements associated with the reference or the object beam that is not being blocked, (d) making another determination as to whether the first diffraction efficiency is reached, and upon determining that the first diffraction efficiency is not reached, repeating operations (a) to (d) until the first diffraction efficiency is reached.

Another aspect of the disclose embodiments relates to a system for production and real-time measurement of diffraction efficiency of a hologram. The system includes a first optical component positioned to receive a reference beam and direct the reference beam towards a location of a holographic material for formation of a diffraction grating thereon, and a second optical component positioned to receive an object beam and to direct the object beam towards a location of the holographic material for formation of the diffraction grating thereon. The system further includes a chopper or a shutter positioned to block a path of one of the reference or the object beams to prevent the corresponding beam to reach the holographic material for at least a portion of time during which the diffraction grating is being formed, as well as a detector positioned to receive a diffracted beam associated with the reference or the object beam that is not being blocked, and to generate electrical signals indicative of one or more power levels associated with the reference or the object beam that is incident on the detector. The above noted system additionally includes a processor and a memory coupled to the processor. The memory includes instructions stored thereon, wherein the instructions upon execution by the processor cause the processor to determine, based on information associated with the electrical signals indicative of one or more power levels whether a first diffraction efficiency is reached, and upon a determination that the first diffraction efficiency is reached, cause one of the reference or the object beams to be blocked while allowing the other of the reference or the object beams to illuminate the holographic material with a particular duty cycle. The instructions upon execution by the processor also cause the processor to determine, based on measurements of diffraction efficiency using the reference beam or the object beam that is not blocked or otherwise disabled, whether a final diffraction efficiency is reached.

In one example embodiment, the instructions upon execution by the processor cause the processor to control a duty cycle or a frequency of operation of the chopper or the shutter. In another example embodiment, the chopper or the shutter is positioned to block the object beam, and the detector is positioned to receive the diffracted beam associated with the reference beam when the object beam is blocked. In still another example embodiment, the chopper or the shutter is positioned to block the reference beam, and the detector is positioned to receive the diffracted beam associated with the object beam when the reference beam is blocked. In yet another example embodiment, the system further includes at least one laser light source configured to generate, or be used to generate, the reference beam or the object beam.

According to one example embodiment, the first or the second optical components include one or more of: a lens or a mirror. In another example embodiment, the above noted system is configured to illuminate the holographic material using a total internal reflection (TIR) configuration. In yet another example embodiment, the above noted system is configured to illuminate the holographic material using a non-total internal reflection (non-TIR) configuration. In one example embodiment, the system includes at least one prism.

At least part of the disclosed embodiments may be implemented using a system that includes at least one processor and/or controller, at least one memory unit that is in communication with the processor, and at least one communication unit that enables the exchange of data and information, directly or indirectly, through the communication link with other entities, devices, databases and networks. Such processors, controllers, and the associated memory and communication unit can be incorporated as part of the computer. The communication unit may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. For example, the processor and memory may be used conduct computations to determine whether a desired diffraction efficiency has reached, to control the shutters, choppers and the light sources, to receive or transmit information from or to the disclosed detectors, and/or to control other components that are shown and described herein.

The processor(s) may include central processing units (CPUs) to control the overall operation of, for example, the host computer. In certain embodiments, the processor(s) accomplish this by executing software or firmware stored in memory. For example, the processor may be programmed to process the information that it obtained from the polarization cameras to obtain a phase difference or a depth measurement. The processor(s) may be, or may include, one or more programmable general-purpose or special-purpose microprocessors, digital signal processors (DSPs), programmable controllers, application specific integrated circuits (ASICs), programmable logic devices (PLDs), graphics processing units (GPUs), or the like, or a combination of such devices.

The memory represents any suitable form of random access memory (RAM), read-only memory (ROM), flash memory, or the like, or a combination of such devices. In use, the memory may contain, among other things, a set of machine instructions which, when executed by processor, causes the processor to perform operations to implement certain aspects of the presently disclosed technology.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Only a few implementations and examples are described and other implementations, enhancements and variations can be made based on what is described and illustrated in this patent document.

What is claimed is:

1. A method for production and real-time measurement of a hologram, comprising:
directing a reference beam and an object beam toward a holographic material for formation of a diffraction grating in the holographic material;
blocking the reference beam or the object beam to prevent the corresponding beam to reach the holographic material for at least a portion of time during which the diffraction grating is being formed;
upon blockage of one of the reference or object beams, measuring a power level of a diffracted beam associated with the reference or the object beam that is not being blocked;
determining whether or not a first diffraction efficiency that is different from a final diffraction efficiency is reached based on the measured power level,
upon a determination that the first diffraction efficiency is reached, blocking or otherwise disabling one of the reference or the object beams while allowing the other of the reference or the object beams to illuminate the holographic material with a particular duty cycle to enable further measurements of diffraction efficiency, and
conducting the further measurements of the diffraction efficiency using the reference or the object beam that is not blocked or otherwise disabled until the final diffraction efficiency is reached.

2. The method of claim 1, wherein the final diffraction efficiency is reached when the measured diffraction efficiency either saturates or reaches a maximum value.

3. The method of claim 1, wherein determining whether or not the first diffraction efficiency is reached includes comparing the measured power level to a stoppage point power value.

4. The method of claim 3, wherein the stoppage point power value is related to a power value associated with the final diffraction efficiency by a non-linear relationship.

5. The method of claim 1, wherein the particular duty cycle is less than 50 percent, having an on-time that is less than an off-time in each cycle.

6. The method of claim 5, wherein the particular duty cycle is 10% or less.

7. The method of claim 1, wherein upon the determination that the first diffraction efficiency is reached, blocking or otherwise disabling the object beam while allowing the reference beam to illuminate the holographic material with the particular duty cycle.

8. The method of claim 1, wherein blocking one of the reference or the object beams includes operating a chopper that periodically blocks a path of one of the reference beam or the object beam.

9. The method of claim 1, wherein blocking one of the reference or the object beams includes operating a shutter that intermittently or periodically blocks a path of one of the reference beam or the object beam.

10. The method of claim 1, wherein
blocking one of the reference or the object beams while the diffraction grating is being formed consists of blocking the object beam, and
measuring the power level of the diffracted beam consists of measuring the power level of the diffracted reference beam.

11. The method of claim 1, wherein
blocking one of the reference or the object beams while the diffraction grating is being formed consists of blocking the reference beam, and
measuring the power level of the diffracted beam consists of measuring the power level of the diffracted object beam.

12. The method of claim 1, comprising, upon a determination that the first diffraction efficiency is not reached,
(a) allowing both the reference beam and the object beam to illuminate the holographic material to continue formation of the diffraction grating,
(b) subsequent to illumination of the holographic material by both the reference and object beams for a duration of time, blocking one of the reference or the object beams,
(c) making one or more additional power level measurements associated with the reference or the object beam that is not being blocked,
(d) making another determination as to whether the first diffraction efficiency is reached, and
upon determining that the first diffraction efficiency is not reached, repeating operations (a) to (d) until the first diffraction efficiency is reached.

13. A system for production and real-time measurement of diffraction efficiency of a hologram, comprising:
a first optical component positioned to receive a reference beam and direct the reference beam towards a location of a holographic material for formation of a diffraction grating thereon;
a second optical component positioned to receive an object beam and to direct the object beam towards a location of the holographic material for formation of the diffraction grating thereon;
a chopper or a shutter positioned to block a path of one of the reference or the object beams to prevent the corresponding beam to reach the holographic material for at least a portion of time during which the diffraction grating is being formed;
a detector positioned to receive a diffracted beam associated with the reference or the object beam that is not being blocked, and to generate electrical signals indicative of one or more power levels associated with the reference or the object beam that is incident on the detector; and
a processor and a memory coupled to the processor, the memory including instructions stored thereon, wherein the instructions upon execution by the processor cause the processor to:
determine, based on information associated with the electrical signals indicative of one or more power levels whether a first diffraction efficiency is reached, and upon a determination that the first diffraction efficiency is reached, cause one of the reference or the object beams to be blocked while allowing the other of the reference or the object beams to illuminate the holographic material with a particular duty cycle, and
determine, based on measurements of diffraction efficiency using the reference beam or the object beam that is not blocked or otherwise disabled, whether a final diffraction efficiency is reached.

14. The system of claim 13, wherein the instructions upon execution by the processor cause the processor to control a duty cycle or a frequency of operation of the chopper or the shutter.

15. The system of claim 13, wherein the chopper or the shutter is positioned to block the object beam, and the detector is positioned to receive the diffracted beam associated with the reference beam when the object beam is blocked.

16. The system of claim 13, wherein the chopper or the shutter is positioned to block the reference beam, and the detector is positioned to receive the diffracted beam associated with the object beam when the reference beam is blocked.

17. The system of claim 13, further comprising at least one laser light source configured to generate, or be used to generate, the reference beam or the object beam.

18. The system of claim 13, wherein the first or the second optical components include one or more of: a lens or a mirror.

19. The system of claim 13, wherein the system is configured to illuminate the holographic material using a total internal reflection (TIR) configuration.

20. The system of claim 13, wherein the system is configured to illuminate the holographic material using a non-total internal reflection (non-TIR) configuration.

21. The system of claim 13, wherein the system includes at least one prism.
